(19) United States
(12) Patent Application Publication
(10) Pub. No.: US 2025/0079573 A1
(43) Pub. Date: Mar. 6, 2025

(54) HEAT EXCHANGER BATTERY

(71) Applicant: Bayview Investments (AUST) Pty Ltd, Mysterton, QLD (AU)

(72) Inventor: Reuben Richardson, Mysterton, QLD (AU)

(21) Appl. No.: 18/726,375

(22) PCT Filed: Feb. 24, 2023
(86) PCT No.: PCT/AU2023/050127

§ 371 Date: Jul. 2, 2024

(30) Foreign Application Priority Data
Feb. 25, 2022 (AU) 2022900449
Jul. 13, 2022 (AU) 2022901955

(51) Int. Cl. H01M 10/663; H01M 10/613; H01M 10/627; H01M 10/6567; H01M 10/6569

(52) U.S. Cl. CPC H01M 10/663; H01M 10/613; H01M 10/627; H01M 10/6567; H01M 10/6569; H01M 2220/10

(57) ABSTRACT

A heat exchanger battery comprising an insulated container containing a first heat transfer medium having a first temperature; a plurality of cells in the container for contact with the first heat transfer medium; each cell comprising a conductive casing surrounding a compressible core (if required), and a volume of a second heat transfer medium having a second temperature; wherein circulation of the first heat transfer medium through the insulated container effects a transfer of thermal energy between the first heat transfer medium and the second heat transfer medium in a direction according to a difference of the first temperature and the second temperature; and wherein the compressible core prevents damage to the conductive casing by deforming in response to expansion of the volume of the second heat transfer medium.

### CROSS-REFERENCE TO RELATED APPLICATIONS

This application is a national phase entry under 35 U.S.C. § 371 of International Patent Application PCT/AU2023/050127, filed Feb. 24, 2023, designating the United States of America and published as International Patent Publication WO 2023/159275 A1 on Aug. 31, 2023, which claims the benefit under Article 8 of the Patent Cooperation Treaty of Australian Patent Application Serial No. 2022900449, filed Feb. 25, 2022, and of Australian Patent Application Serial No. 2022901955, filed Jul. 13, 2022.

### TECHNICAL FIELD

The disclosure relates to a heat exchanger battery for the storage of thermal energy.

### BACKGROUND

Any references to methods, apparatus or documents of the prior art are not to be taken as constituting any evidence or admission that they formed, or form part of, the common general knowledge.

Thermal energy storing apparatuses are known. Thermal energy storing apparatuses may be used for a number of different uses, in particular, for use with heating, ventilation and air conditioning (HVAC) equipment. Such apparatuses can provide desired indoor conditions without requiring substantial energy input during peak times of the energy consumption from the electrical grid.

Thermal energy storing apparatuses that require less maintenance and are more efficient at storing and transferring thermal energy without damage to componentry are sought.

### BRIEF SUMMARY

In an aspect, the disclosure provides a heat exchanger battery comprising:
an insulated container containing a first heat transfer medium having a first temperature;
a plurality of cells in the insulated container for contact with the first heat transfer medium;
each cell comprising a conductive casing surrounding a compressible core, the compressible core storing a volume of a second heat transfer medium having a second temperature;
wherein circulation of the first heat transfer medium through the insulated container effects a transfer of thermal energy between the first heat transfer medium and the second heat transfer medium in a direction according to a difference of the first temperature and the second temperature; and
wherein the compressible core prevents damage to the conductive casing by deforming in response to expansion of the volume of the second heat transfer medium.

In an embodiment, the heat exchanger battery is provided in combination with a refrigeration circuit arranged to reduce the first temperature below the second temperature and circulate the first heat transfer medium through the container to thereby cool the second heat transfer medium in a first mode of operation.

In an embodiment, the refrigeration circuit is external to the insulated container.

In an embodiment, the heat exchanger battery is configured to transfer thermal energy from the first heat transfer medium to the second heat transfer medium in a second mode of operation wherein the second temperature is less than the first temperature and wherein the refrigeration circuit is inoperative.

In an embodiment, the heat exchanger battery is provided in combination with an air conditioner arranged to cool a building wherein the air conditioner is coupled to the heat exchanger battery for receiving the first coolant medium therefrom.

In an embodiment, the first heat transfer medium comprises glycol or glycol solution.

In an embodiment, the second heat transfer medium comprises water or water solution.

In an embodiment, the conductive outer casing comprises a metal casing.

In an embodiment, the metal casing is comprised of aluminum or copper.

In an embodiment, the compressive core comprises a resilient foam.

In another aspect, the disclosure provides a heat exchanger battery comprising:
an insulated container comprising one or more inlets and one or more outlets for circulating a first heat transfer medium therethrough;
a plurality of cells disposed within the insulated container, each cell comprising a conductive casing surrounding a compressible core and storing a volume of a second heat transfer medium;
wherein the first heat transfer medium is circulated through the insulated container thereby transferring thermal energy between the first heat transfer medium and the second heat transfer medium; and
wherein the compressible core prevents damage to the conductive casing by deforming in response to expansion of the volume of the second heat transfer medium.

In an aspect, the disclosure provides a heat exchanger battery comprising:
an insulated container containing a first heat transfer medium having a first temperature;
a plurality of cells in the insulated container for contact with the first heat transfer medium;
each cell comprising a conductive casing storing a volume of a second heat transfer medium having a second temperature;
wherein circulation of the first heat transfer medium through the insulated container effects a transfer of thermal energy between the first heat transfer medium and the second heat transfer medium in a direction according to a difference of the first temperature and the second temperature; and
wherein the second heat transfer medium is configured to prevent damage to the conductive casing by having minimal to no expansion of the second heat transfer medium.

In an embodiment, the second heat transfer medium comprises a phase change material.

In another aspect, the disclosure provides a method of storing thermal energy in a heat exchanger battery comprising:
providing an insulated container comprising one or more inlets and one or more outlets;
providing a plurality of cells disposed within the insulated container, each cell comprising a conductive casing surrounding a compressible core and storing a volume of a second heat transfer medium;
circulating a first heat transfer medium through the insulated container; and
transferring thermal energy between the first heat transfer medium and the second heat transfer medium.

In an embodiment, the method further comprises adapting the second heat transfer medium to change phases at a desired temperature.

In an embodiment, the method further comprises expanding the second heat transfer medium as it changes phase.

In an embodiment, the method further comprises expanding the second heat transfer medium by changing it from a liquid to a solid.

In an embodiment, the method further comprises compressing the compressible core as the second heat transfer medium expands.

In another aspect, the disclosure provides a method of manufacturing a heat exchanger battery comprising:
providing an insulated container for storing a first heat transfer medium and having one or more inlets and one or more outlets;
locating a plurality of cells within the insulated container, each cell comprising a conductive outer casing surrounding a compressible core;
configuring each cell to store a volume of a second heat transfer medium; and storing a volume of a heat transfer medium within each cell.

According to a further aspect of the disclosure, there is provided a method for cooling a building comprising:
in a first mode of operation:
   operating a refrigeration assembly to cool a first heat transfer medium;
   circulating the first heat transfer medium from the refrigeration assembly through a heat exchanger battery comprising:
      an insulated container;
      a plurality of cells disposed within the insulated container, each cell containing a conductive casing surrounding a compressible core storing a volume of a second heat transfer medium to thereby transfer heat from the second heat transfer medium to the first heat transfer medium and cool the second heat transfer medium; and
in a second mode of operation during which the refrigeration assembly is inoperative:
   allowing heat to transfer from the first heat transfer medium to the second heat transfer medium to thereby cool the first heat transfer medium; and
   providing the cooled first heat transfer medium to an air conditioning system arranged to cool the building, wherein the air conditioning system transfers heat from the building to the cooled first heat transfer medium.

According to a further aspect of the disclosure, there is provided a method for heating a building comprising:
in a first mode of operation:
   operating a heating assembly to heat a first heat transfer medium;
   circulating the first heat transfer medium from the heating assembly through a heat exchanger battery comprising:
      an insulated container;
      a plurality of cells disposed within the insulated container, each cell containing a conductive casing storing a volume of a second heat transfer medium to thereby transfer heat from the first heat transfer medium to the second heat transfer medium and heat the second heat transfer medium; and
in a second mode of operation during which the heating assembly is inoperative:
   allowing heat to transfer from the first heat transfer medium to the second heat transfer medium to thereby heat the first heat transfer medium; and
   providing the heated first heat transfer medium to a heating system arranged to heat the building, wherein the heating system transfers heat from the heated first heat transfer medium to the building.

### BRIEF DESCRIPTION OF THE DRAWINGS

Preferred features, embodiments and variations of the disclosure may be discerned from the following Detailed Description that provides sufficient information for those skilled in the art to perform the disclosure. The Detailed Description is not to be regarded as limiting the scope of the preceding Summary of the Disclosure in any way. The Detailed Description will make reference to a number of drawings as follows:

FIG. 1 is a schematic view of a system comprising the heat exchanger battery for use in cooling according to an embodiment of the disclosure.

FIG. 2 is a top view of the insulated container of FIG. 1.

FIG. 3 is a top view of a cell of FIG. 1.

FIG. 4 is a side view of the cell of FIG. 3.

FIG. 5 is a schematic view of a system comprising the heat exchanger battery for use in heating according to an embodiment of the disclosure.

### DETAILED DESCRIPTION

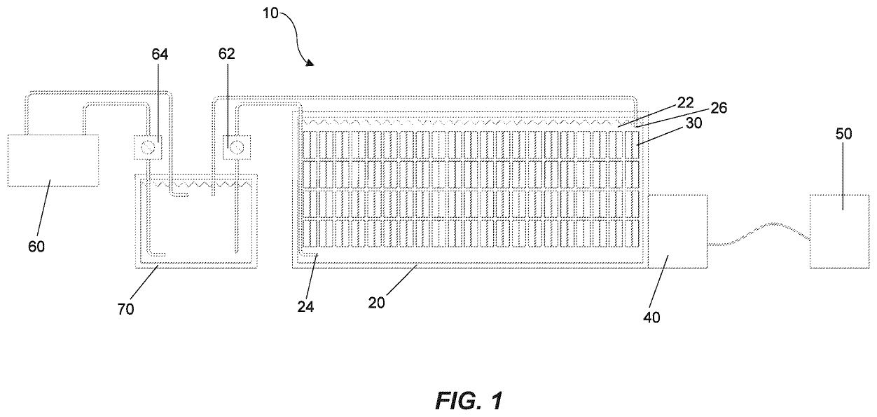

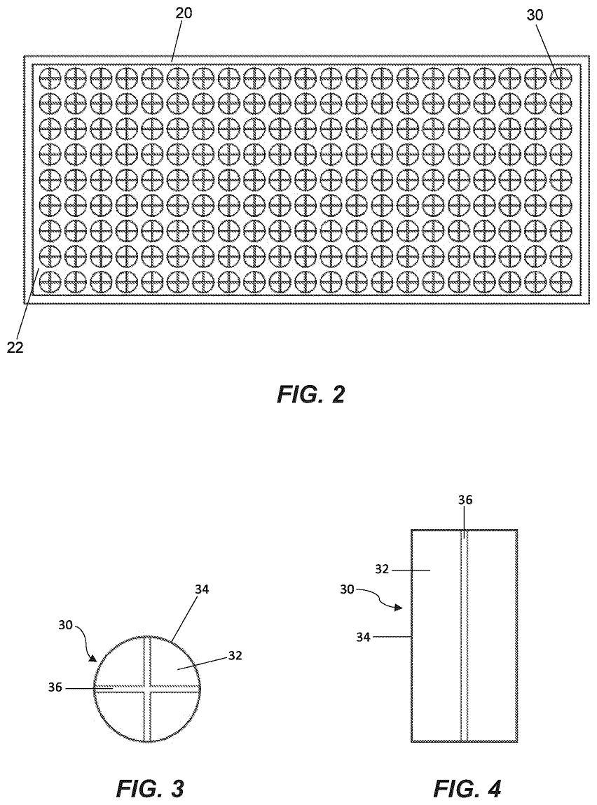

FIGS. 1 to 4 illustrate a non-limiting example embodiment of a system that utilizes a heat exchanger battery 10 according to an embodiment of the disclosure. The heat exchanger battery 10 comprises an insulated container 20 or tank having a plurality of cells 30 located within the insulated container 20. The insulated container 20 being substantially filled with a first heat transfer medium 22. In the preferred embodiment, the first heat transfer medium 22 or material comprises a glycol or a glycol solution. The person skilled in the art would appreciate that a number of heat transfer mediums or materials may be used provided it has a lower freezing point than a heat transfer medium within the cells 30.

Referring to FIGS. 3 and 4, each of the plurality of cells 30 within the insulated container 20 comprise a conductive outer jacket or casing 34 and a compressible core 36 within the conductive outer jacket or casing 34. The conductive outer jacket or casing 34 preferably comprises a metal, such as copper or aluminum. Preferably, the plurality of cells 30 are substantially rigid. The plurality of cells 30 may allow for some flexibility to account for minor amounts of contraction and/or expansion. The compressible core 36 preferably comprises a resilient foam. It should be appreciated that the conductive outer jacket or casing 34 and the compressible core 36 may comprise a plurality of materials and/or compositions. The preferable characteristic of the conductive outer jacket or casing 34 is that it is suitable for transferring thermal energy between each cell 30 and the surrounding first heat transfer medium 22. The preferable characteristic of the compressible core 36 is a low resistance to being compressed and being resilient to return to an unbiased form. Preferably, the compressible core 36 is permeable so as to allow a second heat transfer medium 32 or material to be in contact substantially entirely with an inner surface of the outer jacket or casing 34. Alternatively, or in combination, the compressible core may be configured to be spaced from the inner surface so as to allow the second heat transfer medium 32 to be in direct contact with the inner surface of the outer jacket or casing 34.

Each cell 30 is preferably substantially filled with a volume of a second heat transfer medium 32. In the preferred embodiment, the second heat transfer medium 32 comprises a water or a water solution. The second heat transfer medium 32 is suitable for providing a capacity to absorb thermal energy. The person skilled in the art would readily appreciate that an infinite number and/or compositions of the first heat transfer medium 22 and the second heat transfer medium 32 may be utilized.

The number of cells 30 is dependent on the demand required of the heat exchanger battery 10. Accordingly, where a system requires a larger amount of energy a higher number of cells 30 may be required relative to a system that requires a relatively lower amount of energy.

### Cooling

Preferably, during a first mode of operation for a cooling configuration, the first heat transfer medium 22 is circulated to keep the first heat transfer medium 22 at a first temperature. The second heat transfer medium 32 is at a second temperature. During operation, the temperature of the first heat transfer medium 22 is relatively lower than the temperature of the second heat transfer medium 32. The first heat transfer medium 22 is circulated through the insulated container 20 so as to allow thermal energy to transfer to the second heat transfer medium 32 through conduction. The first heat transfer medium 22 is in direct contact with the outer jacket or casing 34 of each of the plurality of cells 30. A temperature differential between the first heat transfer medium 22 and the second heat transfer medium 32 results in thermal energy transferring from the second heat transfer medium 32 within each of the plurality of cells 30 to the first heat transfer medium 22 within the insulated container 20. After a period of time, the second heat transfer medium 32 may reach a point where it is in equilibrium with the first heat transfer medium 22.

The first heat transfer medium 22 in the insulated container 20 may be circulated through a refrigeration circuit 40, such as one known in the art. The refrigeration circuit 40 circulates the first heat transfer medium 22 therethrough so as to keep the temperature of the first heat transfer medium 22 within the insulated container 20 lower than or equal to the temperature of the second heat transfer medium 32. For example, the refrigeration circuit 40 may maintain the first heat transfer medium 22 at a temperature between 0° to −20° C. The first heat transfer medium 22 may be maintained at a temperature of −10°, −30°, −40°, −50°, −60° C., etc. The first heat transfer medium 22 may be maintained at a temperature between 0° to −60° C. or more in increments of 0.1° C. For example, when using a glycol solution as the first heat transfer medium 22, the glycol solution may be maintained at a temperature of −15.2° C. Preferably, the first heat transfer medium 22 is maintained at a temperature that does not impede its ability to flow. The ideal temperature will therefore be dependent at least in part on the composition of the first heat transfer medium 22. The person skilled in the art would readily appreciate that the temperature of the first heat transfer medium 22 may be maintained at any temperature. However, at a certain point the energy consumption required to lower the temperature and keep the first heat transfer medium 22 at the lowered temperature will outweigh the energy consumption and/or capacity of the refrigeration circuit 40. The heat exchanger battery 10 may comprise a thermostat to reduce and/or turn off the refrigeration circuit 40 if equilibrium is achieved or the temperature of the second heat transfer medium 32 decreases below a predetermined temperature.

Preferably, the refrigeration circuit 40 is in fluid communication so as to receive the first heat transfer medium 22 directly from the insulated container 20. However, the refrigeration circuit 40 may be positioned remote from the insulated container 20 and the necessary supply and return conduits may be insulated. Furthermore, while the refrigeration circuit 40 is shown in FIG. 1 as being annexed to the insulated container 20, in alternative embodiments, it may be incorporated within the insulated container 20. Preferably, a supply line for the first heat transfer medium 22 from the insulated container 20 to the refrigeration circuit 40 is located opposite or at least spaced a distance from a return line for the second heat transfer medium 32 to the insulated container 20.

After a sufficient amount of thermal energy has been transferred from the second heat transfer medium 32 to the first heat transfer medium 22, the second heat transfer medium 32 may change phases (i.e., from a liquid to a solid). For example, if the second heat transfer medium 32 is water, at 0° Celsius the water will begin to freeze and expand. The compressible core 36 is compressed in accordance with the expansion of the second heat transfer medium 32. The outer jacket or casing 34 is undamaged due to the compressible core 36 compressing to accommodate for the expanding second heat transfer medium 32. As such, the volume of the second heat transfer medium 32 within each cell 30 may be determined by the amount of compressible core 36 present within each cell 30. Each cell 30 is preferably designed to ensure the inner surface is substantially always in contact with the second heat transfer medium 32.

In the preferred embodiment, the refrigeration circuit 40 is entirely, or at least in part, powered by a renewable energy source, such as a solar panel 50. Alternatively, or in combination, with the solar panel 50, the renewable energy source may further comprise a wind turbine or other renewable energy source (not shown) to generate or assist in generating power to circulate the first heat transfer medium 22 through the refrigeration circuit 40. The refrigeration circuit 40 may also comprise means to store power from the renewable energy source to be used when the renewable energy source is no longer producing power, such as when the sun sets. As mentioned above, the refrigeration circuit 40 may also draw auxiliary power from the local electrical grid. The solar panel 50 and/or other renewable energy sources (not shown) may also be used in conjunction with the heating aspect as discussed in more detail below.

In an alternative embodiment, the heat exchanger battery 10 may configured in a second mode of operation for a cooling configuration wherein thermal energy is transferred from the first heat transfer medium 22 to the second heat transfer medium 32. The first heat transfer medium 22 circulating through the insulated container 20 such that thermal energy transfers to the second heat transfer medium 32 through the conductive outer jacket or casing 34 by way of conduction. In such instance, the temperature of the second heat transfer medium 32 is lower than the temperature of the first heat transfer medium 22. When the aforementioned temperature differential occurs, thermal energy is transferred from the first heat transfer medium 22 to the second heat transfer medium 32 thereby decreasing the temperature of the first heat transfer medium 22. For example, this may occur when the refrigeration circuit 40 is inoperative, which may be due to no power or an insufficient amount to operate the refrigeration circuit 40.

As seen in FIG. 1, the heat exchanger battery 10 may be provided in combination with a heating ventilation and air conditioning (HVAC) unit, such as air conditioner 60. The air conditioner 60 may be coupled to the heat exchanger battery 10 for receiving the first coolant medium, such as the first heat transfer medium 22, therefrom and arranged to cool a building. As seen in FIG. 1, the HVAC unit may also comprise a holding container 70 for storing the first coolant medium to ensure a necessary supply of the first coolant medium to the air conditioner 60. The holding container 70 is preferably insulated similarly, or identical, to insulated container 20. The system may further comprise one or more pumps 64 for assisting in the circulation of the first coolant medium to/from the holding container 70. Furthermore, the system may comprise one or more pumps 62 for assisting in pumping the first heat transfer medium 22 to/from the insulated container 20. Additional pumps may be provided on the return lines (not shown). In an alternative embodiment, the holding container 70 may not be present and air conditioner 60 may be provided with the first heat transfer medium 22 directly from the insulated container 20.

As seen in FIG. 1 and mentioned above, the insulated container 20 of the heat exchanger battery 10 may comprise one or more inlets 24 and one or more outlets 26. The first heat transfer medium 22 is circulated through the insulated container 20 from the one or more inlets 24 to the one or more outlets 26. Preferably, the one or more inlets 24 and the one or more outlets 26 are located on opposite sides of the insulated container 20. The location of the one or more inlets 24 relative to the one or more outlets 26 may assist in ensuring a more uniform temperature throughout the first heat transfer medium 22 within the insulated container 20. By extension this may result in a more uniform temperature of the second heat transfer medium 32 in each of the plurality of cells 30.

The method of storing thermal energy in the heat exchanger battery 10 will be discussed with reference to the figures generally.

Beginning with a heat exchanger battery 10 as discussed herein, the first heat transfer medium 22 is pumped through the insulated container 20. The first heat transfer medium 22 may be pumped into the insulated container 20 through the one or more inlets 24. Alternatively, or in combination, the first heat transfer medium 22 may be pumped out from the insulated container 20 through the one or more outlets 26. The first heat transfer medium 22 being pumped through the insulated container 20 is at a temperature different than the temperature of the second heat transfer medium 32 within each of the plurality of cells 30. As the first heat transfer medium 22 is pumped through the insulated container 20, thermal energy is conductively transferred between the first heat transfer medium 22 and the second heat transfer medium 32.

As previously discussed, the second heat transfer medium 32 can be formulated to change phases at a desired temperature. The change in phase is preferably from a liquid to a solid (i.e., freezing). A characteristic of water is that as it freezes, it expands. As such, the cells 30 of the disclosure have been designed so as to accommodate for the expansion of the second heat transfer medium 32 by compressing the compressible core 36 in each of the plurality of cells 30. The second heat transfer medium 32 may comprise water or a water solution. Accordingly, additives may be included to give the second heat transfer medium 32 additional desirable properties, for example, a lower or higher freezing point.

The heat exchanger battery 10 may be manufactured in a number of different ways. In particular, there are an infinite number of ways in which the plurality of cells 30 may be arranged. Most preferably, the plurality of cells 30 within the insulated container 20 are arranged such that the surface area between the outer jacket or casing 34 and the first heat transfer medium 22 would be maximized. Each of the plurality of cells 30 may be manufactured in individual units or modules and inserted into a framework or suspended by wires or other connection means within the insulated container 20. Each of the plurality of cells 30 may be manufactured having a connector on opposing sides for connecting together and/or to the insulated container 20. While the plurality of cells 30 are disclosed as being substantially cylindrical, the plurality of cells 30 may be any shape that allows for the transfer of thermal energy between the first heat transfer medium 22 and the second heat transfer medium 32. For example, the cells 30 may be spherical or a mix and match of different or alternating shapes so as to delay or lengthen the amount of thermal energy transferred and the time required to transfer the thermal energy to/from each of the plurality of cells 30.

### Heating

The above description is disclosed for use in the cooling of a building. However, the heat exchanger battery 10 may also be useful when used in a heating process. When used in the heating process, thermal energy is transferred from the first heat transfer medium 22 through the conductive outer jacket or casing 34 and stored in the second heat transfer medium 32. The first heat transfer medium 22, having a relative higher temperature than the second heat transfer medium 32, is circulated through the insulated container 20 comprising a plurality of cells 30 storing the second heat transfer medium 32. Preferably, the plurality of cells 30 store a phase change material or medium. The phase change material when at a relatively hotter is in liquid form and when at a relatively cooler temperature is solid. Furthermore, the phase change material may be chosen as it has minimal to no expansion as it changes from solid phase to liquid phase and vice versa. Phase change material has higher storage density than comparable mediums. Preferably, the second heat transfer medium 32 comprises a wax type material (for example, beeswax, lard or paraffin wax). Alternatively, the second heat transfer medium 32 may comprise a thermal oil, a water solution or a water-glycol solution. The second heat transfer medium 32 may be chosen based on the desired temperature to be maintained. Furthermore, the second heat transfer medium 32 may be chosen based on the melting point of the medium.

The plurality of cells 30 used in the heating process may also comprise the compressible core 36 as discussed above in the cooling process. Alternatively, the plurality of cells 30 used in the heating process may comprise a different structure as the expansion of the second heat transfer medium 32 may have less expansion/contraction. Furthermore, the plurality of cells 30 may also be of a different structure (i.e., more or less rigid) due to less expansion/contraction. The compressible core 36 may assist in suspending the second heat transfer medium 32 more evenly throughout each of the plurality of cells 30. This also increases the amount of the second heat transfer medium 32 in direct contact with the conductive outer jacket or casing 34. Furthermore, if there is a small amount of expansion, the compressible core 36 may assist in ensuring the conductive outer jacket or casing 34 is undamaged throughout the cycle of transferring and storing thermal energy between the first heat transfer medium 22 and the second heat transfer medium 32 and vice versa. Accordingly, the structure of the plurality of cells 30 may be determined by the second heat transfer medium 32 and/or whether the heat exchanger battery 10 will be used for heating and/or cooling.

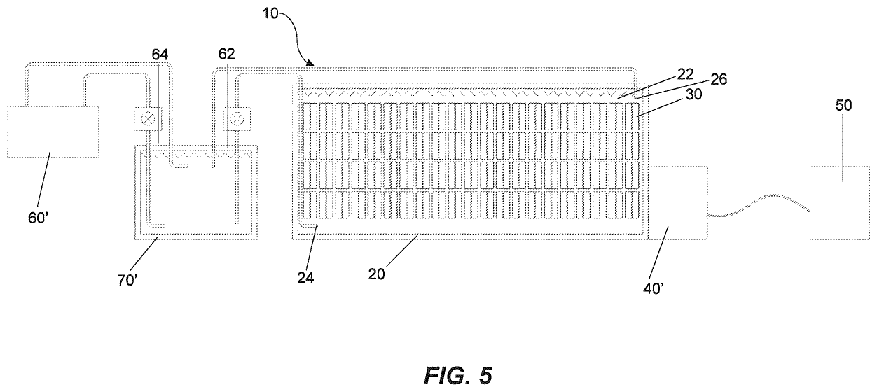

Referring to FIG. 5, there is provided an example system having the heat exchanger battery 10 wherein the heating unit 60′ and holding container 70′. The holding container 70′ comprises the first heat transfer medium 22. The holding container 70′ heats up and maintains the temperature of the first heat transfer medium 22 at a relatively high temperature for use in transferring thermal energy to the second heat transfer medium 32 stored in the plurality of cells 30. Transfer of thermal energy is through conduction.

In a first mode of operation of heating, a heating circuit 40′ heats the first heat transfer medium 22. The first heat transfer medium 22 is circulated through the insulated container 20. The first heat transfer medium 22 has a relatively higher temperature than the second heat transfer medium 32 present in each of the plurality of cells 30. Due to the temperature differential, thermal energy transfers from the first heat transfer medium 22 to the second heat transfer medium 32 through the conductive outer jacket or casing 34 of each of the plurality of cells 30. Preferably, the first heat transfer medium 22 is maintained at a temperature between 30° to 60° C. However, the person skilled in the art would readily appreciate that the first heat transfer medium 22 maintained at a temperature of 40°, 50°, 70°, 80°, 90° C., etc. The temperature of the first heat transfer medium 22 may be maintained at a temperature between 30° to 90° C. or more in increments of 0.1° C. For example, the first heat transfer medium 22 may be maintained at 43.1° C.

Once the temperature differential between the first heat transfer medium 22 and the second heat transfer medium 32 is substantially zero. When the temperature differential is substantially zero, the heat exchanger battery 10 operates without thermal energy transferring between the first heat transfer medium 22 and the second heat transfer medium 32.

In a second mode of operation of heating, the heating assembly is inoperative. As such, the first heat transfer medium 22 is no longer being heated by the heating circuit 40′. Accordingly, as the temperature of the first heat transfer medium 22 drops below the relative temperature of the second heat transfer medium 32, thermal energy transfers from the second heat transfer medium 32 through the conductive outer jacket or casing 34 to the first heat transfer medium 22. At its highest temperature, the second heat transfer medium 32 may be in liquid form. As the thermal energy is transferred from the second heat transfer medium 32 is transferred to the first heat transfer medium 22, the second heat transfer medium 32 may solidify. The plurality of cells 30 may be “recharged” by transferring thermal energy to the second heat transfer medium 32 through the conductive outer jacket or casing 34 by heating the first heat transfer medium 22 to a desired temperature of the second heat transfer medium 32.

The disclosure is particularly advantageous in that it utilizes the latent heat capacity of the second heat transfer medium 32 without increasing the storage volume. Furthermore, the disclosure preferably utilizes at least one renewable energy source (e.g., solar panel 50) to provide the input energy required to store the thermal energy or the capacity to absorb thermal energy in the plurality of cells 30. With minimal to no expansion/contraction of the second heat transfer medium 32, the lifespan of the plurality of cells 30 is increased. Furthermore, the increased lifespan of the plurality of cells 30 may also reduce the respective maintenance requirements.

Throughout the specification, the preferred embodiment uses the phrase “heat transfer medium” to describe a fluid or a solid, such as ice. However, “medium” should be interpreted broadly where context allows. For example, the “heat transfer medium” may be interpreted to be a heat transfer gas.

The specification above uses headings for ease of reading. The headings should not be limiting in any way on the disclosure. Accordingly, the aspects and features as disclosed under the section titled “Cooling” may also be utilized with the aspects and features disclosed under the section titled “Heating” and vice versa.

In compliance with the statute, the disclosure has been described in language more or less specific to structural or methodical features. The term “comprises” and its variations, such as “comprising” and “comprised of” is used throughout in an inclusive sense and not to the exclusion of any additional features.

It is to be understood that the disclosure is not limited to specific features shown or described since the means herein described comprises preferred forms of putting the disclosure into effect.

The disclosure is, therefore, claimed in any of its forms or modifications within the proper scope of the appended claims appropriately interpreted by those skilled in the art.

1. A heat exchanger battery comprising:
an insulated container containing a first heat transfer medium having a first temperature; and
a plurality of cells in the insulated container for contact with the first heat transfer medium, each cell comprising a conductive casing surrounding a compressible core, the compressible core storing a volume of a second heat transfer medium having a second temperature;
wherein circulation of the first heat transfer medium through the insulated container effects a transfer of thermal energy between the first heat transfer medium and the second heat transfer medium in a direction according to a difference of the first temperature and the second temperature; and
wherein the compressible core prevents damage to the conductive casing by deforming in response to expansion of the volume of the second heat transfer medium.

2. The heat exchanger battery according to claim 1, wherein the heat exchanger battery is provided in combination with a refrigeration circuit arranged to reduce the first temperature below the second temperature and circulate the first heat transfer medium through the insulated container to thereby cool the second heat transfer medium in a first mode of operation.

3. The heat exchanger battery according to claim 2, wherein the refrigeration circuit is external to the insulated container.

4. The heat exchanger battery according to claim 2, wherein the heat exchanger battery is configured to transfer thermal energy from the first heat transfer medium to the second heat transfer medium in a second mode of operation wherein the second temperature is less than the first temperature and wherein the refrigeration circuit is inoperative.

5. The heat exchanger battery according to claim 1, wherein the heat exchanger battery is provided in combination with an air conditioner arranged to cool a building wherein the air conditioner is coupled to the heat exchanger battery for receiving the first heat transfer medium therefrom.

6. The heat exchanger battery according to claim 1, wherein the first heat transfer medium comprises glycol or a glycol solution.

7. The heat exchanger battery according to claim 1, wherein the second heat transfer medium comprises water or a water solution.

8. The heat exchanger battery according to claim 1, wherein the conductive casing comprises a metal casing.

9. The heat exchanger battery according to claim 8, wherein the metal casing is comprised of aluminum or copper.

10. The heat exchanger battery according to claim 1, wherein the compressible core comprises a resilient foam.

11. A heat exchanger battery comprising:
an insulated container comprising one or more inlets and one or more outlets for circulating a first heat transfer medium therethrough; and
a plurality of cells disposed within the insulated container, each cell comprising a conductive casing surrounding a compressible core and storing a volume of a second heat transfer medium;
wherein the first heat transfer medium is circulated through the insulated container thereby transferring thermal energy between the first heat transfer medium and the second heat transfer medium; and
wherein the compressible core prevents damage to the conductive casing by deforming in response to expansion of the volume of the second heat transfer medium.

12. A heat exchanger battery comprising:
an insulated container containing a first heat transfer medium having a first temperature; and
a plurality of cells in the insulated container for contact with the first heat transfer medium, each cell comprising a conductive casing storing a volume of a second heat transfer medium having a second temperature;
wherein circulation of the first heat transfer medium through the insulated container effects a transfer of thermal energy between the first heat transfer medium and the second heat transfer medium in a direction according to a difference of the first temperature and the second temperature; and
wherein the second heat transfer medium is configured to prevent damage to the conductive casing by having minimal to no expansion of the second heat transfer medium.

13. The heat exchanger battery according to claim 12, wherein the second heat transfer medium comprises a phase change material.

14. A method of storing thermal energy in a heat exchanger battery comprising:
providing an insulated container comprising one or more inlets and one or more outlets;
providing a plurality of cells disposed within the insulated container, each cell comprising a conductive casing surrounding a compressible core and storing a volume of a second heat transfer medium;
circulating a first heat transfer medium through the insulated container; and
transferring thermal energy between the first heat transfer medium and the second heat transfer medium.

15. The method according to claim 14, wherein the method further comprises adapting the second heat transfer medium to change phases at a desired temperature.

16. The method according to claim 14, wherein the method further comprises expanding the second heat transfer medium as it changes phase.

17. The method according to claim 14, wherein the method further comprises expanding the second heat transfer medium by changing it from a liquid to a solid.

18. The method according to claim 14, wherein the method further comprises compressing the compressible core as the second heat transfer medium expands.

19. A method of manufacturing a heat exchanger battery comprising:
providing an insulated container for storing a first heat transfer medium and having one or more inlets and one or more outlets;
locating a plurality of cells within the insulated container, each cell comprising a conductive outer casing surrounding a compressible core;
configuring each cell to store a volume of a second heat transfer medium; and
storing the volume of the second heat transfer medium within each cell.

20. A method for cooling a building comprising:
in a first mode of operation:
operating a refrigeration assembly to cool a first heat transfer medium;
circulating the first heat transfer medium from the refrigeration assembly through a heat exchanger battery comprising:
an insulated container; and
a plurality of cells disposed within the insulated container, each cell containing a conductive casing surrounding a compressible core storing a volume of a second heat transfer medium to thereby transfer heat from the second heat transfer medium to the first heat transfer medium and cool the second heat transfer medium; and
in a second mode of operation during which the refrigeration assembly is inoperative:
allowing heat to transfer from the first heat transfer medium to the second heat transfer medium to thereby cool the first heat transfer medium; and
providing the cooled first heat transfer medium to an air conditioning system arranged to cool the building, wherein the air conditioning system transfers heat from the building to the cooled first heat transfer medium.

21. A method for heating a building comprising:
in a first mode of operation:
operating a heating assembly to heat a first heat transfer medium; and
circulating the first heat transfer medium from the heating assembly through a heat exchanger battery comprising:
an insulated container; and
a plurality of cells disposed within the insulated container, each cell containing a conductive casing storing a volume of a second heat transfer medium to thereby transfer heat from the first heat transfer medium to the second heat transfer medium and heat the second heat transfer medium; and
in a second mode of operation during which the heating assembly is inoperative:
allowing heat to transfer from the second heat transfer medium to the first heat transfer medium to thereby heat the first heat transfer medium; and
providing the heated first heat transfer medium to a heating system arranged to heat the building, wherein the heating system transfers heat from the heated first heat transfer medium to the building.
